(19) United States
(12) Patent Application Publication
(10) Pub. No.: US 2015/0248662 A1
(43) Pub. Date: Sep. 3, 2015

(54) Portable device for financial transactions

(71) Applicant: FG s.r.l. AGENZIA FINANZIARIA, Roma (IT)

(72) Inventor: Giorgio Fiorelli, Roma (IT)

(73) Assignee: FG S.r.l. AGENZIA FINANZIARIA, Roma (IT)

(21) Appl. No.: 14/427,979

(22) PCT Filed: Sep. 12, 2013
(86) PCT No.: PCT/IT2013/000242

§ 371 Date: Mar. 12, 2015

(30) Foreign Application Priority Data
Sep. 17, 2012 (IT) RM2012A000443

(51) Int. Cl. G06Q 20/32; H04M 1/02; H04B 1/3827; H04M 1/725; G06Q 20/20; G06Q 20/40

(52) U.S. Cl. CPC G06Q 20/3223; G06Q 20/202; G06Q 20/327; G06Q 20/40145; H04B 1/3833; H04M 1/7253; H04M 1/0262

(57) ABSTRACT

The invention relates to a portable device for financial transactions which can be used for safe payments and/or withdrawals of cash in real time and for other forms of credit and/or banking operations in general.

The present invention relates to a portable device for financial transactions which can be used for safe payments and/or withdrawals of cash in real time and for other forms of credit and/or banking operations in general.

In the technical sector of electronic money transactions major efforts are being constantly made to develop systems of the “electronic wallet” type where sums of money are withdrawn from an account at an approved bank and are used for the payment of goods or services instead of using cash.

Also known are money transactions performed using “cashpoint card” means which require the keying-in of personal codes, as well as “credit card” means which require confirmation of the owner's signature and in some cases the presentation of an identity document. However, these known means may in some way be fraudulently reproduced or used by users other than the owner, should the said means be lost or stolen.

Also known are payment systems which use prepaid cards, the disadvantage being that they require topping up of the available sum whenever the funds run out and allow payments which are limited by the very nature of the card.

WO 01/35334 and U.S. Pat. No. 5,623,552 disclose credit cards which envisage reading of fingerprints for identification of the owner and authorization for financial transfers.

US 2007/0220273 discloses a card for transactions which uses the input of biometric identification data and a wireless system for communicating an access code in the vicinity of a reader or a transaction system.

WO 2011/065807 discloses known solutions for high-security real-time money transactions which use mobile phones.

However, although improvements are being continually made in order to increase the safety and practical nature of the known systems, with none of these systems is it possible to obtain the certainty that the user is effectively the legitimate owner of the credit means; moreover, with none of these known systems is it possible to have a single means or a single device which may be electronic and which simultaneously performs the function of a credit card, cashpoint card and cash.

Moreover, all the known systems which use “badge” type means, such as credit cards or cashpoint cards, are subject to dimensional requirements of the ISO 7810 standards whereby they must have a well-defined maximum thickness which results in the necessary use—for example for the types with fingerprint recognition means—of thin mono-dimensional sensors which are less reliable than other types of sensors which have greater thicknesses and cannot be used in these cards. In fact, as mentioned, in order to comply with the requirements stipulated in the ISO standards, the badge means must have a limited thickness so as to be able to bend or twist along all the axes without being damaged.

These known systems therefore have the disadvantage that they envisage three separate means for the functions which are normally used in money transactions, namely credit card, cashpoint card and cash card.

Moreover, these known means have limitations in terms of their thickness and are prone to damage, which may occur for example inside one's pocket or wallet, owing to their small thickness.

Moreover, the type of recognition sensor of these known means must have a small thickness so that they can be used with badge means, with the result that they must be preferably of the mono-dimensional type, typically in the form of a single strand, which is less reliable and difficult to read. In the aforementioned case other types of sensors with a greater thickness cannot be used.

In fact the known means do not ensure a bi-unique and non-reproducible correspondence between the legitimate users of the credit means during a financial transaction of the type involving money transfers, since both the codes of the cashpoint cards and the signatures of the credit cards as well as wireless access operations, such as those described in the publication US 2007/022073, may be fraudulently intercepted, reproduced and used by non-authorized third parties.

A further disadvantage of the known devices consists in the impossibility of transferring sums of money between credit cards or cashpoint cards.

The object of the present invention is therefore to provide a portable device which allows a money transaction to be performed safely in real time, so as to replace credit cards, cashpoint cards and cash with a single means, which portable device is able to be perform the detection of biometric data, such as fingerprints, store said data for subsequent use and authenticate in a certain manner the validity of each subsequent transaction request made by the user, confirming that the person performing the transaction is the legitimate owner, or, alternatively, a person legitimately authorized by the owner of the credit means and empowered for this purpose, the biometric data of said person being those stored, without having to key in codes or provide signatures or transmit data remotely, allowing bank access directly without the use of codes or PINs.

This means, as will be described more clearly below, that the fingerprints stored in the device may belong also to several trusted persons known by the owner as well as the owner him/herself, whereby each fingerprint may have its own spending limit or ceiling.

Another object of the present invention is to perform the wireless communication between device and reader linked to the POS terminal exclusively in a protected and confined space so that the electromagnetic, optical or similar waves remain within said space and are not propagated within the environment.

A further object of the present invention is to provide a portable device which does not involve additional management costs when used for cash transactions.

A further object of the present invention is to provide a portable device which, in the event of loss or theft, cannot be used by unauthorized third parties since the biometric data, such as one or more fingerprints, cannot be recognized.

A further object of the present invention is to provide a portable device which allows the transfer of sums of money between portable devices, for example by using a special reader with two slots for connection to a computer in turn connected to the data system network of the bank managing the bank account associated with the portable device from which the sum of money to be transferred to another portable device is withdrawn (the latter being for example the computer of the owner of the portable device from which the sum of money is withdrawn); this reader, by allowing the simultaneous connection of two portable devices, may allow sums of money to be transferred between the associated bank accounts connected to them with the guarantee of the presence of the owners of the accounts provided by verification of the fingerprints. Other systems may envisage the same fund transfer operation performed by means of readers with a single slot each connected to a respective computer (in turn connected to the data system of the bank corresponding to the portable device), such as the computers of the respective owners of the portable device. This operation may be performed along the lines of or using the same procedures as those used for Home Banking with the indispensable physical participation of each owner who must convalidate the entire operation by providing his/her fingerprint enabled for this purpose.

Yet another object of the present invention is to ensure greater convenience, practicality of use and robustness compared to the known systems, including also credit cards which envisage recognition by means of fingerprints. In fact, according to the present invention, there are no limitations in terms of thickness, as in the case of conventional badges; consequently there is no risk of damage due to bending or the like, allowing the use of more sensitive and reliable sensors.

Another further object of the present invention is that of providing a device which is directly connected to the bank account and which, owing to its practical and immediate nature, may also be used to manage the payment of insignificant sums, such as that required to buy a coffee, bus ticket or newspaper, without additional costs, also managing cash in a different manner, since by being able to withdraw exact sums, the device can be used to make purchases down to a very small amount, without having to keep in one's pocket loose change which is often no longer considered or is lost or ignored for use as cash.

According to the present invention, the following is provided: a portable device which comprises essentially a biometric data reader, preferably any type of data sensor and in particular, for example a fingerprint sensor of the bi-dimensional, capacitive, resistive, optical or similar type, a power supply unit or a battery suitable for supplying electric power to the portable device, which may or may not co-operate with an associated recharging system; circuits for reading and storing the biometric data, preferably for example fingerprints, as well as for subsequently identifying and validating said data, in order to associate in a certain manner the portable device according to the invention with the legitimate owner or legitimate user and allow the subsequent identification, recognition and validation of the said biometric data of the owner or the legitimate user. The aforementioned battery, in addition to being able to be recharged, may be readily replaced with a new one since it will be housed preferably inside a special, extractable, side drawer, without this operation requiring opening of the portable device since the entire device will be protected by a physical anti-tamper system described further below. This replacement of the battery, as and when required, may be particularly useful when the main battery runs out of charge and no suitable recharging means are available on-site. The need for immediate recharging of the battery, or replacement thereof, may be signalled with visual means of the LED type or other signals also of the acoustic type.

The portable device according to the present invention is also envisaged as being able to communicate wirelessly with a reader linked to a POS (Point of Sale) terminal of a retail outlet. This wireless communication is performed exclusively in an extremely confined and protected receiving space so that the electromagnetic, optical or similar radiation for communication between the portable device and the reader linked to the POS terminal remains within the receiving seat or space and is not propagated within the environment, thus avoiding any possible interception and reproduction thereof.

These and other characteristic features of the present invention will become clear from the detailed description which follows of a non-limiting example of a preferred embodiment of the portable device according to the invention with reference to the figures in the accompanying drawings in which:

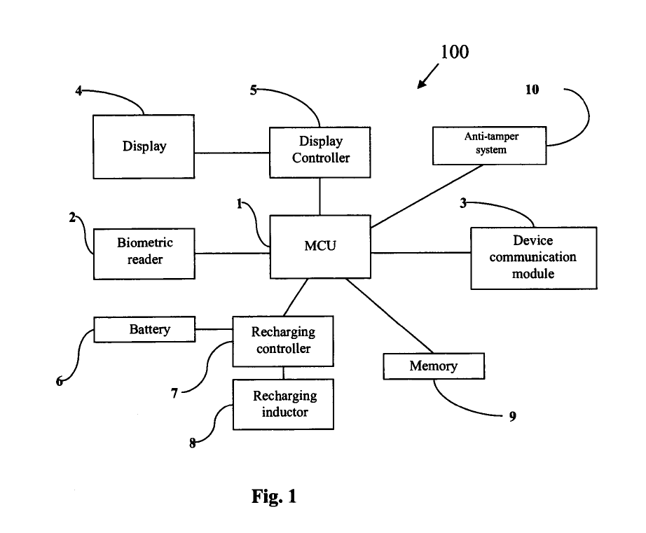

FIG. 1 shows the block diagram of the portable device according to the invention;

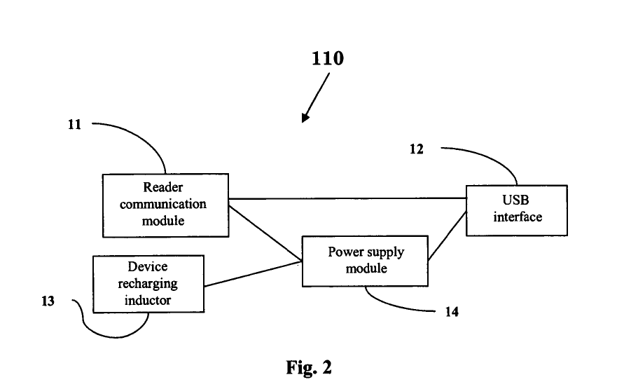

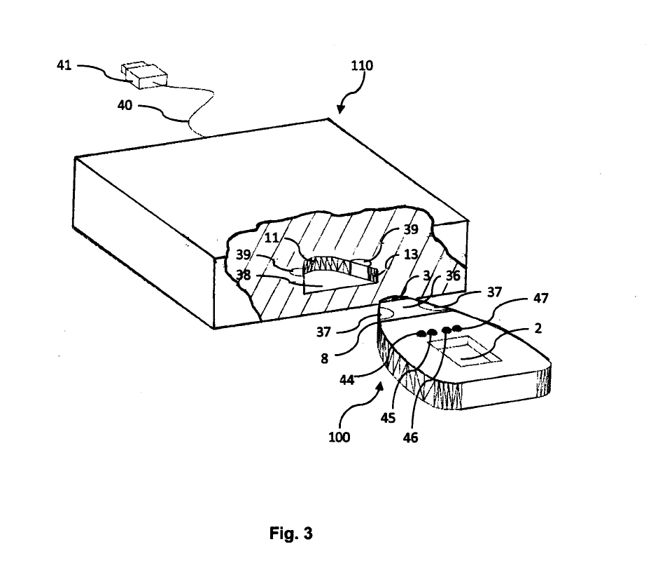

FIG. 2 shows the block diagram of the reader linked to the POS terminal and intended to communicate with the portable device according to the invention;

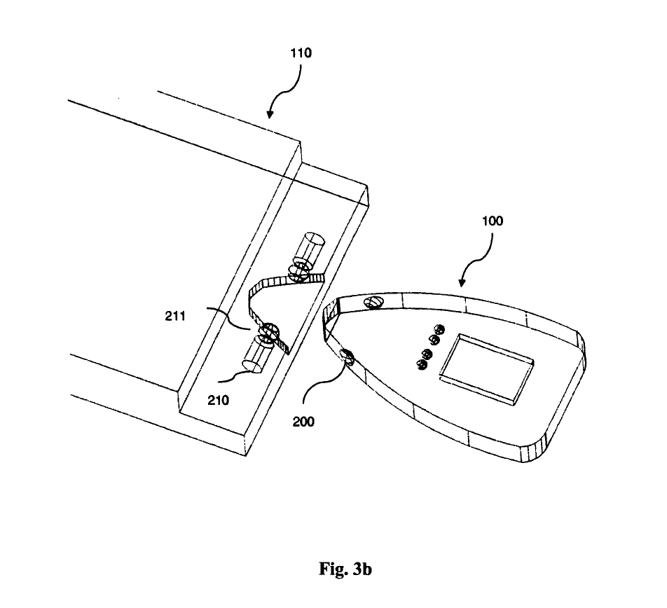

FIG. 3 shows, according to the invention, in a schematic manner opposite each other, a portable device and a corresponding reader;

FIG. 3b show one of the possible variations of the system for engagement between the reader and device, consisting of spring-loaded balls as described below;

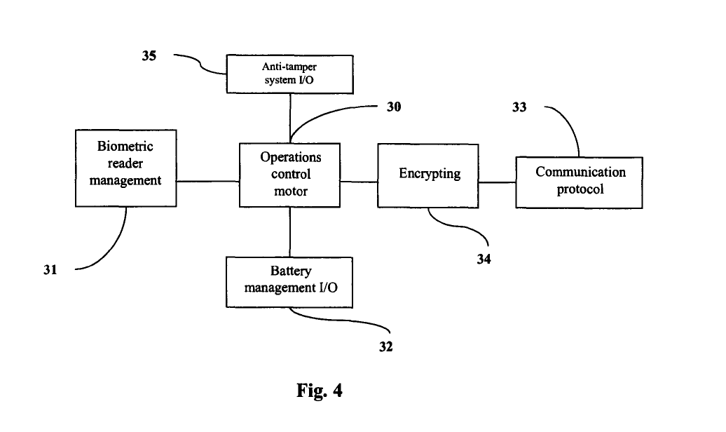

FIG. 4 shows in detail the block diagram of the program for operation of the micro controller unit (MCU); and

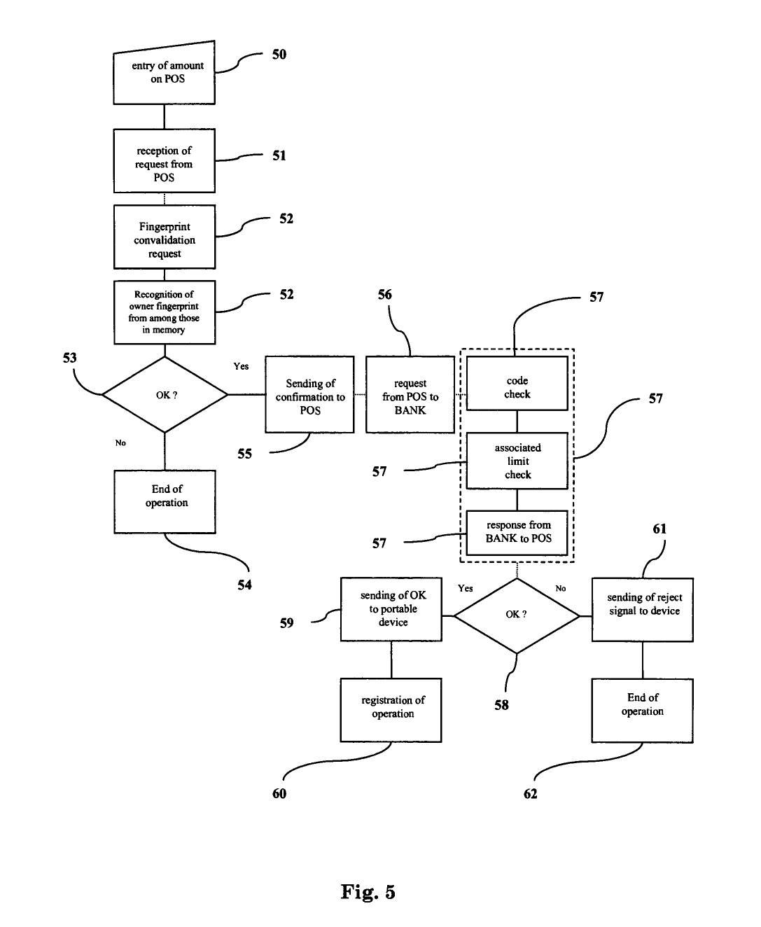

FIG. 5 shows the flow diagram of an example of a transaction which uses, according to the invention, the portable device in combination with the corresponding reader linked to the POS.

With reference to FIGS. 1 and 2 these show the block diagram of a preferred embodiment of a portable device 100 according to the invention and an associated reader 110 communicating with it.

In particular, the portable device 100 comprises a microprocessor or micro controller unit (MCU) 1 to which a biometric reader of any known type 2, at least one communication module 3 and optionally a display 4 with associated control circuits 5 are connected. A power supply battery 6 is also connected to the MCU 1 and can be replaced and/or recharged via a recharging controller 7 which controls a recharging means 8 of any suitable type, for example preferably of the inductive type.

An optional additional memory 9 and optional anti-tamper system 10 may also be connected to the MCU 1.

The reader 110 shown in FIG. 2 comprises essentially a communication module 11 designed for communication from and to the communication module 3 of the portable device 100, an interface 12 preferably of the USB type or other known types and, in any case of the type designed not to emit waves externally, linked to a POS terminal. A recharging device 13 of any suitable type, for example of the inductive type, connected by means of a power supply module 14 to the electricity mains, also forms an essential part of the reader 110.

More particularly, the device 100 is contained within a housing which has a form convenient for use in a simple and ergonomic manner with one hand (left or right hand as required), having dimensions approximately the same as those, for example, of a cigarette lighter or an electronic car key.

This housing contains the components shown in the block diagram of FIG. 1 and in particular the MCU 1 which controls the entire portable device 100 and is activated by the legitimate user positioning at least one prechosen finger on the surface of the biometric reader 2 and exerting a more or less light pressure on the said surface so as to close the circuit of any activation means providing power to the entire device 100. The activation means may consist, for example, of a microswitch which is positioned underneath the said biometric sensor 2 or a capacitive, resistive or proximity sensor which is provided in any convenient position of the device.

Activation of the device is confirmed by means of displaying of a suitable message on a display or by means of lighting up of one or more micro LEDs.

More particularly, the biometric reader 2 may be any fingerprint reader, preferably a sensor of the bi-dimensional capacitive, resistive, optical or similar type.

The biometric sensor 2 reads the fingerprint which is formed on its surface and informs the MCU 1, which carries out an initial qualitative evaluation thereof. Once the quality thereof has been approved, the MCU 1, via the device communication module 3 connected to a reader communication module 11 according to FIG. 2, receives the information for:
starting the operations for recording one or more fingerprints in the memory of the MCU 1 and/or in the additional memory 9 of the device, assigning to each fingerprint a numerical, position or other type of identifier or code and, once the entire recording operation has been completed, preventing the addition to and/or variation of the recorded data, if this reader is situated at the bank, or
checking that the fingerprint itself belongs to the legitimate user and that it is therefore already recorded in the memory of the MCU and/or in the additional memory 9, if this reader is connected to a POS.

The housing of the device also contains a recharging controller 7. This definition is understood as meaning preferably any means which is able to monitor periodically the charged state of the battery 6 of the portable device 100 and, if necessary, request rapid recharging or replacement thereof, indicating this need by means of LEDs and/or acoustic signals.

The operations described hitherto may be performed if the recharging controller 7 gives its consent, after checking that the voltage level present in the battery 6 is sufficient to power the necessary components of FIG. 1 for positive completion of the required operation. If this is not the case, the recharging controller 7 signals the need for recharging and/or requests activation of a recharging means 8 for example preferably of the inductive type, whereby this signal may also be silenced by means of replacement of the battery as mentioned above.

Protection of the integrity and accuracy of the biometric information contained in the memory of the MCU 1 and/or in any additional memory 9 (information which in the example of embodiment of the present invention consists for example of one or more fingerprints, i.e. up to ten fingerprints) is ensured by one or more anti-tamper systems 10 which, in the case of an attempt to perform forced opening of the portable device 100, instantaneously render the latter illegible and unusable.

A non-limiting example of the anti-tamper system 10 may envisage means able to send all the residual voltage of the battery 6 to the terminals of the memory circuit of the MCU 1 and the additional memory 9, causing the immediate destruction thereof.

Clearly, it is possible to envisage a battery, for example of the lithium type, dedicated solely for the anti-tamper system 10 alone and never used for other purposes.

Alternatively, it is possible to envisage mechanical predefined-breakage means or chemical means such as phials containing a suitable corrosive substance.

The portable device according to the present invention may also envisage that one or more of the recorded fingerprints is used by the system to emit a silent alarm signal which the circuit concerned (for example the reader 110) will use in a suitable manner, indicating forced or anomalous operation of the device to the central control unit of the bank concerned. The bank in turn will relay suitable alarm signals, where necessary, to the police or security companies, while it will send communication messages, and not alarm signals, to the POS, these not being listed here.

FIGS. 1, 2 and 3 and in particular FIG. 3 show a preferred example of embodiment of the assembly consisting of the portable device 100 and the corresponding reader 110 to which it is to be connected. The mutual physical contact between the device 100 and the reader 110 is maintained by at least one magnetic means 37, 39 associated with either one of the device 100 or the reader 110 and interacting with a complementary engaging element 39, 37 provided on the reader 110 or on the portable device 100.

Even more particularly, in the embodiment shown, the portable device 100 has a front end 36 provided with at least one magnetic means 37 preferably consisting of at least one pair of magnets 37, while the reader 110 has a receiving seat 38 which has internally at least one complementary magnetic engaging element 39 preferably consisting of at least one pair of magnets 39. When the front end 36 of the portable device 100 is inserted inside the receiving seat 38 of the reader 110, the magnets 37 and 39 respectively provided, as said, on the end 36 of the portable device 100 and inside the receiving seat 38 of the reader 110 in corresponding positions firmly keep the portable device 100 in contact with the reader 110 so that the respective device communication module 3 and reader communication module 11 remain in close physical contact and may exchange data without emitting waves of any type externally.

The symmetrical form of the device 100 could give rise to incorrect positioning of the said device inside the reader 110, for example, in the case where an optional communication unit for reception/transmission (RX TX) between the two components, i.e. device and reader, is involved. In fact, in order to comply with the need to maintain within an extremely confined space the exchange of information, the RX side of the device 110 side must be placed in physical contact with the TX side of the device 100, and vice versa. This result is obtained by providing in a suitable position within the receiving seat 38 of the reader 110 two magnets 39 which have facing polarities so as to come into contact with two similar magnets 37 arranged on the surface of the front end 36 of the device 100. The polarities of the magnets will ensure that correct positioning of the device 100 inside the reader 110 corresponds to secure locking together of the two elements, while incorrect positioning of the device 100 inside the reader 110 produces expulsion of the device from the reader owing to the magnetic repulsion effect. In this case, wireless communication between device 100 and reader 110 takes place only when the former is correctly seated inside the latter, the dissipation externally of wireless data communication waves being zero or substantially zero.

Clearly, if the magnetic means 39 of the reader 110 are composed of electromagnets, the force of the latter may be adjusted so as to be maximum during use and practically zero at the end of the operations, for easy extraction of the device from the receiving seat 38.

Preferably, as shown in FIG. 3, for the sake of convenience of use the arrangement of the parts which form the device 100 and the corresponding reader 110 is such as to allow horizontal insertion of the device 100 inside the reader 110.

A different arrangement (not shown) of the parts may also be envisaged where the two components, device 100 and reader 110, are arranged vertically; in this case, for example, the magnetic means 39 of the reader 110 interact with a complementary engaging element 37 made of ferromagnetic material arranged on the portable device 100, or vice versa, so as to ensure the possibility of use with either the right hand or left hand, as required.

It is also possible to obtain an effective, purely mechanical, engaging action, as shown in FIG. 3b, between the device 100 and the reader 110 with the aid of a resilient system consisting of a pair of springs 210 which are housed in the reader 110 inside the receiving seat 38; each spring 210 has one end integrally joined to the reader 110, while the other end is integrally joined to a small ball 211 (or other projecting object) which, when the respective spring 210 is in the rest position, projects slightly from the seat housing the spring 210 itself. The device 100 is provided with a pair of corresponding, preferably semi-spherical cavities 200 which are positioned laterally on the front end 36 so that, when the front end 36 of the portable device 100 is inserted inside the receiving seat 38 of the reader 110, the pair of cavities 200 of the former are located opposite the pair of balls 211.

In this way, insertion of the device 100 inside the reader 110 compresses initially the springs 210 since the respective end balls 211 are pushed inside the housing of the springs 210 until the respective end balls 211 penetrate inside the two cavities 200, thus retaining the portable device 100 inside the receiving seat 38 of the reader 110; in order to remove the portable device 100 from the reader 110, it will be sufficient for a user to exert a force greater than a threshold value (dependent on—and where possible able to be regulated by means of adjustment of—the elastic constant of the springs 210, dimensions of the springs 210, seats of the latter, balls 211 and cavities 200). The correct positional engagement between the reception side and transmission side of the optical communication assembly of the device 100 and the reader 110 may be mutually ensured by means of the form asymmetry of the profile of both of them in the parts intended to be arranged in contact with each other, so that incorrect insertion of the device 100 in the reader 110 is mechanically impossible. Alternatively, the pair of springs 210 (with the respective balls 211) and the pair of cavities 200 may be exchanged with each other in the relative arrangement of portable device 100 and reader 110, so that the former may be provided with a pair of springs 210 (with the respective balls 211) and the latter may be provided with a pair of respective cavities 200.

Furthermore, the portable device 100 (or the reader 110) may be provided with one or more springs 210 which are integrally joined to respective end balls 211 (in positions and arrangements which are also different from those shown in FIG. 3b) corresponding to respective cavities 200 present on the reader 110 (or on the portable device 100) and with one or more cavities 200 (in positions and arrangements also different from those shown in FIG. 3b), corresponding to respective springs 210 which are integrally engaged with respective end balls 211 present on the reader 110 (or on the portable device 100).

The correct introduction into the space or receiving seat and the correct recognition of the fingerprint are preferably signalled by suitable lighting up of at least one LED provided for this purpose, as will be explained more fully hereinbelow.

The portable device 100 is provided, for example, with LEDs 44, 45, 46 and 47 which have specific functions and meanings;
the LED 44 indicates correct insertion or positioning of the device 100 inside the reader 110 and confirmation of locking of the magnets 37, 39 or the balls 211 at the ends of the springs 210 inside the cavities 200 (detected, for example, by means of pressure/presence sensors);
the LED 45 indicates that the fingerprint has been correctly stored;
the LED 46 indicates that the fingerprint has been recognized as valid and as therefore belonging to the legitimate user;
the LED 47 indicates that an error condition has occurred: the fingerprint is not recordable or has not been recognized as belonging to the correct user.

Lighting up of one or more LEDs during normal use of the portable device may signal the need to recharge the battery or, if necessary, replace it.

The reader 110, via the interface 12, preferably of the USB type and such as not to emit waves externally, associated electric cable 40 and connector 41, receives from the POS terminal or from the bank registration computer suitable instructions as to what the device 100 must do:
perform payment when requested by the sales point;
analyze the fingerprint detected on the biometric reader 2; and
record it in the memories of the MCU 1 and additional memory 9 of the same device 100 together with a numerical, position or other type of identifier or code.

During this stage of the operations the reader 110 and the device 100 also keep the recharging inductors 13 and 8, respectively, in close contact with each other so that a correct power supply may be provided via them to the device 100 in the case where recharging of the device 100 is not sufficient to perform the required operations.

FIG. 4 shows in particular the operating program of the microprocessor MCU 1 which comprises an operations control motor 30, which implements the logic functions for managing the biometric reader 31. The operations control motor 30 also implements the I/O logic functions for managing the battery 32. Furthermore the operations control motor 30 manages the communication protocol 33 with the reader 110, preferably via an encryption routine 34.

The operations control motor 30, finally, deals with the I/O of the anti-tamper system 35, where present.

More particularly, FIG. 4 shows the functions which are performed inside the MCU 1 under its direct control.

In particular, the operations control motor 30 cyclically monitors the channels for communication from and to:
the routine 34 for encryption of the communication protocol 33;
checks for any notifications from the anti-tamper system 35;
the routine 31 for management of the biometric reader 2;
checks the I/O signals of the controller of the battery 32.

Considering the time sequence of the operations, the latter are performed as follows:
activation of the device generated by introduction of the same inside the reader or in contact therewith and request for positioning a suitable finger on the sensor in order to activate with a slight pressure the fingerprint reading and identification circuits;
communication, by the reader to the operations control motor 30, via the communication protocol 33 and the encryption routine 34, of the operations which are to be performed;
reading of the fingerprint or the fingerprints via the routine 31 for management of the biometric reader 2;
storage of the fingerprint or fingerprints (if at the bank for authorization of the device user) together with a numerical, position or other type of identifier or code;
recognition of the fingerprint or fingerprints and of the numerical, position or other type of identifier or code for enabling execution of a financial operation where each numerical, position or other type of identifier or code may authorize different daily limits for use;
in the I/O time delays of any one of the channels connected to the operations control motor 30, the control motor itself interrogates the routine for managing the battery 32 and/or the routine for managing the anti-tamper system 35.

FIG. 5 shows the flow diagram of a standard example of a financial transaction comprising the steps of:
50 introduction of the amount on the POS
51 reception of request from the POS
52 request for convalidation of the fingerprint
53 verification by the biometric reader control unit 31 that the fingerprint belongs to the legitimate owner of the portable device 100
54 termination of the operation if the fingerprint is not convalidated by the verification function 53
55 sending of confirmation to the POS if the fingerprint is convalidated together with the associated numerical, position or other type of identifier or code
56 request from the POS to the payment bank with the associated numerical, position or other type of identifier or code
57 response of the bank to the POS with checking of the code and associated limit
58 verification of the financial availability and spending limit for that fingerprint by means of the associated numerical, position or other type of identifier or code
59 if affirmative, sending of OK signal to portable device 100
60 recording of the operation
61 if negative, sending of reject signal to portable device 100
62 end of operation.

More particularly, the situation shown in the flow diagram according to FIG. 5 may refer to an operation for the purchase of goods or services to be performed at an agreed trading establishment via a bank which has adopted the system for use of the portable device 100.

Therefore, the operation (step 50) for introduction of the amount to be paid to the POS terminal occurs as the conclusion of the sales operation. At this point, the POS terminal asks the purchaser to insert the portable device 100 into the associated reading unit 110. Thereafter, the request (step 51) for payment by the POS terminal is received from the MCU 1 which requests in turn (step 52), for example via lighting up of a signalling LED, application by the owner of the device 100, on the biometric reader 2, of one of his/her fingerprints previously recorded at the bank so as to allow verification thereof. It should be pointed out that, together with the data of the owner of the device, a series of numerical, position or other type of codes or identifiers (one for each fingerprint), for each of which a daily spending limit may be agreed and fixed, and not the fingerprint itself, remain stored in the memory of the bank.

There are two possible outcomes for this verification operation (step 53):
the verification proves to be negative, resulting in termination of the operation (step 54)
the verification proves to be positive, resulting in sending of confirmation (step 55) of the validity of the owner's identity and of the associated numerical, position or other type of identifier or code.

All this allows the POS terminal to send to the bank the request for availability of the sum relating to the sales operation in progress for the user indicated by the numerical, position or other type of identifier or code (step 56). Step 57 indicates, together with step 58, the response as to financial availability with checking of the code and spending limit for that given fingerprint which the bank provides to the POS terminal, whereby this response may be:
negative (step 61), resulting directly in the end of the operation (step 62) or
positive (step 59), resulting in regular registration of the accounting operation and successful completion of the sales operation (step 60).

As regards that stated above, a preferred embodiment of the invention has been described, without however limiting it in any way to the characteristic features described. The persons skilled in the art will understand that, in the light of that disclosed here, modifications and numerous changes may be made, including the possibility of using ports of any type, provided that all the safety conditions of the device according to the invention are guaranteed, without departing from the scope of the present invention as defined in the accompanying claims.

The invention claimed is:

1. A system for financial transactions or banking operations, comprising:
at least one portable device (100) and at least one reader (110) connected to an input/output interface (12), said at least one portable device (100) comprising:
a biometric data reader (2) for reading biometric data of at least one legitimate owner of said at least one portable device (100);
an electronic control, processing and storage system (1, 2, 9) configured to perform storage and recognition of the biometric data received by the biometric data reader (2);
a first wireless data communication module (3) connected and controlled by said electronic control, processing and storage system (1, 2, 9); and
a first power supply unit (6, 7, 8) supplying electric power to said at least one portable device (100);
said at least one reader (110) comprising:
a second wireless data communication module (11); and
a second power supply unit (14) supplying electric power to said at least one reader (110);
said at least one reader (100) being provided with a space or receiving seat (38) configured to receive at least one front end (36) of said at least one portable device (100),
wherein said at least one front end (36) of said at least one portable device (100) is provided with a first engaging portion (37; 200) and the receiving seat (38) is provided with a second engaging portion (39; 210, 211) configured to interact with said first engaging portion (37; 200) when said at least one front end (36) of said at least one portable device (100) is inserted inside the receiving seat (38) so as to keep in a stable relative position said at least one portable device (100) and said at least one reader (110), such that said at least one front end (36) of said at least one portable device (100) is configured to be removably inserted inside the receiving seat (38),
said first and second wireless data communication modules (3, 11) being configured to communicate with each other when said at least one front end (36) of said at least one portable device (100) is inserted inside the receiving seat (38), such that dissipation outside of the receiving seat (38) of communication waves between said first and second wireless data communication modules (3, 11) is substantially zero.

2. The system according to claim 1, wherein said first engaging portion comprises a magnetic engaging portion (37), and wherein said second engaging portion comprises a complementary magnetic engaging portion (39).

3. The system according to claim 1, wherein said first engaging portion comprises a first mechanical-engagement portion (200) and said second engaging portion comprises a second mechanical-engagement portion (210, 211).

4. The system according to claim 3,
wherein said second mechanical-engagement portion comprises one or more springs (210) which are housed inside a housing seat situated inside said at least one reader (110), each spring (210) having a first end integrally joined to said at least one reader (110) and a second end integrally joined to a projecting element (211) which, when the spring (210) is in a rest position, projects from the housing seat into the receiving seat (38), and
wherein said first mechanical-engagement portion comprises one or more cavities (200) which are present on said at least one front end (36) of said at least one portable device (100) so that, when said at least one front end (36) of said at least one portable device (100) is inserted in the receiving seat (38), each cavity (200) is located opposite a corresponding projecting element (211), so that the corresponding projecting element (211) penetrates inside the cavity (200) and the projecting elements (211) at the ends of said at least one or more springs (210) stably retain said at least one portable device (100) inside the receiving seat (38).

5. The system according to claim 1, wherein the biometric data reader (2) is a fingerprint sensor, so that said biometric data includes at least one fingerprint.

6. The system according claim 1, wherein said electronic control, processing and storage system of said at least one portable device (100) comprise a microprocessor or micro controller unit MCU (1) to which a display (4) with associated management circuits (5) is connected.

7. The system according to claim 6, wherein an additional memory (9) is connected to the micro controller unit MCU (1).

8. The system according to claim 1, wherein said first power supply unit comprises a power supply battery (6) configured to be replaced or operatively coupled with a recharging controller (7), which controls a recharging unit.

9. The system according to claim 8, wherein the recharging controller (7) is configured to enable operation of said at least one portable device (100) when a voltage level present in the battery (6) is sufficient to power said at least one portable device (100), signalling elsewhere a need for recharging or requesting activation of said recharging unit (8).

10. System The system according to claim 8, wherein said at least one reader (110) comprises a recharging device (13) which can be connected to an electricity network by means a power supply module (14), said recharging device being configured to interact with said recharging unit (8) of said at least one portable device (100) in order to recharge the power supply battery (6) when said at least one front end (39) of said at least one portable device (100) is inserted inside the receiving seat (38).

11. The system according to claim 1, wherein said electronic control, processing and storage system of said at least one portable device (100) further comprises an anti-tamper system (10).

12. The system according to claim 7, wherein said electronic control, processing and storage system of said at least one portable device (100) further comprises an anti-tamper system (10), and wherein the anti-tamper system (10) sends all residual voltage of the battery (6) to terminals of a memory circuit of the MCU (1) and the additional memory (9), causing an immediate destruction thereof.

13. The system according to claim 11, wherein the anti-tamper system comprises a mechanical predefined-breakage or chemical system.

14. The system according to claim 11, wherein said first power supply unit comprise a dedicated battery for the anti-tamper system (10) alone.

15. The system according to claim 1, wherein said electronic control, processing and storage system of said at least one portable device (100) is operative coupled with an activation system activating said power supply unit for activating the power supply of said at least one portable device (100), said activation system being activated by a presence on the biometric data reader (2) of at least one finger of a user.

16. The system according to claim 15, wherein said activation system is chosen from the group consisting of a microswitch positioned underneath the biometric data reader (2), a capacitive sensor, a resistive sensor, and a proximity sensor.

17. The system according to claim 15, wherein said at least one portable device (100) is provided with means for displaying switching-on of said at least one portable device (100), said displaying means comprising a display (4, 5) showing a suitable message or one or more micro LEDs (44, 45, 46, 47).

18. The system according to claim 1, wherein the input/output interface (12) of said at least one reader (110) is configured to be connected to a POS terminal.

19. The system according to claim 1, wherein said at least one portable device (100) or said at least one reader (110) comprise one or more LEDs (44, 45, 46, 47) which are configured to signal activation of said at least one portable device (100), introduction of said at least one portable device (100) inside the receiving seat (38) of said at least one reader (110), validity or recognition of the biometric data detected by the biometric data reader (2) or an error condition.

20. A portable device (100) for use in a system for financial transactions or banking operations, comprising:
a reader (2) configured to read biometric data of at least one legitimate owner of said portable device (100);
an electronic control, processing and storage system (1, 2, 9) configured to perform storage and recognition of the biometric data received by the reader (2);
a first wireless data communication module (3) connected and controlled by said electronic control, processing and storage system (1, 2, 9); and
a first power supply unit (6, 7, 8) configured to supply electric power to said portable device (100),
wherein at least one front end (36) of the portable device (100) is provided with a first engaging system (37; 200) configured to interact with a second engaging system (39; 210, 211) of a receiving seat (38) a second reader (110) so as to keep in a stable relative position the portable device (100) and said reader (110),
said first wireless data communication module (3) being configured to communicate with a second wireless data communication module (11) of the second reader (110) when said at least one front end (36) of the portable device (100) is inserted inside the receiving seat (38) of said at least one reader (110), so that dissipation outside of the receiving seat (38) of communication waves between said first and said second wireless data communication modules (3, 11) is substantially zero.

21. A reader (110) for use in a system for financial transactions or banking operations, connected to an input/output interface (12), comprising:
a second wireless data communication module (11); and
a second power supply unit (14) configured to supply electric power to said reader (110);
the reader (110) being provided with a space or receiving seat (38) configured to receive at least one front end (36) of at least one portable device (100),
wherein the receiving seat (38) is provided with a second engaging system (39; 210, 211) configured to interact with a first engaging system (37; 200) configured to engage at least one front end (36) of the at least one portable device (100) when said at least one front end (36) of said at least one portable device (100) is inserted inside the receiving seat (38) so as to keep in a stable relative position said at least one portable device (100) and the reader (110),
said second wireless data communication module (11) being configured to communicate with a first wireless data communication module (3) of the at least one portable device (100) when the at least one front end (36) of said at least one portable device (100) is inserted inside the receiving seat (38), so that dissipation outside of the receiving seat (38) of communication waves between said first and second wireless data communication modules (3, 11) is substantially zero.

22. A method of performing a standard financial transaction in real time, comprising:
engaging a portable device comprising:
a reader (2) configured to read biometric data of at least one legitimate owner of said portable device (100);
an electronic control, processing and storage system (1, 2, 9) configured to perform storage and recognition of the biometric data received by the reader (2);
a first wireless data communication module (3) connected and controlled by said electronic control, processing and storage system (1, 2, 9); and
a first power supply unit (6, 7, 8) configured to supply electric power to said portable device (100),
wherein at least one front end (36) of the portable device (100) is provided with a first engaging system (37; 200) configured to interact with a second engaging system (39; 210, 211) of a receiving seat (38) of a second reader (110) so as to keep in a stable relative position the portable device (100) and said reader (110), and
wherein said first wireless data communication module (3) is configured to communicate with a second wireless data communication module (11) of the second reader (110) when said at least one front end (36) of the portable device (100) is inserted inside the receiving seat (38) of said at least one reader (110), so that dissipation outside of the receiving seat (38) of communication waves between said first and said second wireless data communication modules (3, 11) is substantially zero,
with a reader (110), comprising:
the second wireless data communication module (11); and
a second power supply unit (14) configured to supply electric power to said reader (110), the reader (110) being provided with a space or receiving seat (38) configured to receive at least one front end (36) of the portable device (100),
wherein the receiving seat (38) is provided with the second engaging system (39; 210, 211) configured to interact with the first engaging system (37; 200) configured to engage at least one front end (36) of the portable device (100) when said at least one front end (36) of said at least one portable device (100) is inserted inside the receiving seat (38) so as to keep in a stable relative position said at least one portable device (100) and the reader (110),
said second wireless data communication module (11) being configured to communicate with the first wireless data communication module (3) of the at least one portable device (100) when the at least one front end (36) of said at least one portable device (100) is inserted inside the receiving seat (38), so that dissipation outside of the receiving seat (38) of communication waves between said first and second wireless data communication modules (3, 11) is substantially zero,
wherein, with the reader, the portable device (100) communicates wirelessly in real time, communication taking place between said first and second wireless data communication modules (3, 11) inside the receiving seat (38).

23. The method according to claim 22, wherein the input/output interface (12) of the reader (110) is connected to a POS terminal, the method comprising the steps of:
introducing an amount on the POS terminal;
receiving a request from the POS terminal;
requesting convalidation of the at least one fingerprint of a user;
verifying with a biometric reader control unit (31) that the fingerprint belongs to a legitimate owner of the portable device (100);
terminating operation if the fingerprint is not convalidated by the verifying step;
confirmation to the POS terminal if the fingerprint is convalidated together with an associated numerical position or other type of identifier or code;
sending a request from the POS terminal to a payment bank with said associated numerical, position or other type of identifier or code;
causing the payment bank to provide a response to the POS terminal and checking code and associated spending limit;
verifying one or both of financial availability or spending limit associated with the fingerprint by said associated numerical, position or other type of identifier or code;
if affirmative, sending an OK signal to the portable device (100);
recording of the operation;
if negative, sending a reject signal to the portable device (100); and
end of operation.
